(19) United States
(12) Patent Application Publication
(10) Pub. No.: US 2011/0083946 A1
(43) Pub. Date: Apr. 14, 2011

(54) Slide Switch

(75) Inventor: Takashi Niiyama, Gunma (JP)

(73) Assignee: HOSIDEN CORPORATION, Yao-shi, Osaka (JP)

(21) Appl. No.: 12/922,559

(22) PCT Filed: Feb. 24, 2009
(86) PCT No.: PCT/JP2009/053276

§ 371 Date: Dec. 8, 2010

(30) Foreign Application Priority Data
Mar. 17, 2008 (JP) 2008-067988

(51) Int. Cl. H01H 15/02

(52) U.S. Cl. 200/16 C

(57) ABSTRACT

A slide switch that can be reduced in thickness comprises a casing C including a sliding-operation detecting section for detecting an operation of a slider 5 in a direction of sliding operation and a depressing-operation detecting section for detecting an operation of the slider 5 in a depressing direction. The casing C is provided with side walls 22 arranged at sides of a square and a bottom wall 21. The bottom wall 21 is constituted with a print-circuit board forming electrodes using a print-wiring technique.

### TECHNICAL FIELD

The present invention relates to a slide switch comprising a sliding element slidable relative to a casing, an urging element for urging the sliding element in an neutral position in a direction of sliding operation, a sliding-operation detecting section for electrically detecting an operation of the sliding element in the direction of sliding operation, and a depressing-operation detecting section for electrically detecting a depressing operation of the sliding element in a direction perpendicular to the sliding-operation detecting section.

BACKGROUND ART

An example of the slide switch having the above-noted construction is disclosed in Patent Document 1, which comprises an urging element provided inside of a square casing and made of an elastically deformable material, rear wall portions formed on the top surface of the urging member at four positions, and a slider acting as a sliding element provided in a base portion of an area surrounded by the rear wall portions.

According to Patent Document 1, one of the rear wall portions is elastically deformed when the slider is slid, as a result of which a conductor provided at a bottom side of the rear wall portion is brought into contact with an associated pair of electrodes provided in the bottom of the casing to establish a conductive state between the pair of electrodes (corresponding to the sliding-operation detecting section of the present invention). On the other hand, when the slider is depressed, the depression force causes the base portion to be elastically deformed and further causes a metal dome arranged at the lower side surface of the urging element, as a result of which the metal dome is brought into contact with an associated electrode provided in the bottom of the casing to establish the conductive state (corresponding to the depressing-operation detecting section of the present invention). Patent Document 1: Japanese Unexamined Patent Application publication No. 2006-310179 (paragraphs 0021 to 0036; FIGS. 1 to 6)

### DISCLOSURE OF THE INVENTION

The slide switch in accordance with Patent Document 1 contributes to reduce the number of parts since the urging element is made of a single material. As a result, miniaturization of the device has been achieved, yet further reduction in thickness has been desired.

In this regard, the arrangement of the slide switch disclosed in Patent Document 1 provides the box-shaped casing including the square bottom integrally formed with four side walls surrounding the bottom. Thus, a predetermined thickness is required to form the bottom of the casing in order to provide essential strength, which has put limits to miniaturization in thickness.

In particular, it is required in the device disclosed in Patent Document 1 that the electrodes should be formed through insert molding in fabricating the casing and the electrodes should be mounted on the casing after the casing is molded in order to form the electrodes in the bottom of the casing. Thus, high accuracy is required for the casing to provide the electrodes.

In addition, when the slide switch including terminals that are conductive with the electrodes and project outward from the casing is mounted on a print-circuit board, it is also required that the terminals should be bent such that the bottom surfaces of the terminals are in the same level as the bottom surface of the casing to perform soldering reliably. Nonetheless, it is sometimes difficult to bend a tiny piece such as a terminal.

The object of the present invention is to provide a slide switch that can be reduced in thickness.

A characteristic feature of the slide switch of the present invention lies in comprising:

a sliding element slidable relative to a casing;

an urging element for urging the sliding element in an neutral position in a direction of sliding operation;

a sliding-operation detecting section for electrically detecting an operation of the sliding element in the direction of sliding operation; and

a depressing-operation detecting section for electrically detecting a depressing operation of the sliding element in a direction perpendicular to the sliding-operation detecting section,

wherein the urging element includes rear wall portions provided in a projecting way at a plurality of positions to hold the sliding element,

wherein the sliding-operation detecting section includes a first electrode formed on a bottom wall of the casing, and a first conductor that is elastically deformed when a pressing force is applied from the sliding element to one of the rear wall portions to come into contact with the first electrode, thereby establishing an electrically conductive condition,

wherein the depressing-operation detecting section includes a second electrode formed in a central position of the bottom wall of the casing, and a conductive plate having a central portion projecting toward the urging element, in which a base wall portion of the urging element corresponding to an area surrounded by the rear wall portions is elastically deformed when the sliding element is depressed to elastically deform the central portion of the conductive plate by a pressing force and bring the conductive plate into contact with the second electrode, thereby establishing the electrically conductive condition, and

wherein the bottom wall is constituted with a print-circuit board formed by a print-wiring technique.

The print-circuit board is made of a material having relatively high strength like a glass epoxy substrate containing glass fiber impregnated with epoxy resin. Using such a print-circuit board as the bottom wall of the casing prevents decrease in strength even if a print-circuit board that is thinner than the bottom wall integrally formed with the casing is used as in the conventional art. That is, the bottom wall having a reduced thickness yet having increased strength may be used without marring the functions of the sliding-operation detecting section and the depressing-operation detecting section. As a result, the rational arrangement of the slide switch that can be reduced in thickness is provided. In particular, since the bottom wall of the casing is made of the print-circuit board, the terminals are easily formed at outer end portions of the print-circuit board using a print-wiring technique, and also formed at fixed positions with high accuracy with respect to the casing.

According to the present invention, the base wall portion may include a portion corresponding to the central portion of the conductive plate that projects toward the sliding element. With this arrangement, the space for accommodating the conductive plate between the urging element and the bottom wall may be increased without changing the arrangement of the whole engaging element.

According to the present invention, the casing may include four side walls provided at each side of a square as viewed from the top,

wherein the second electrode and a ring electrode surrounding the second electrode concentrically are formed on the central position of the bottom wall surrounded by the side walls,

wherein the conductive plate is arranged to be constantly in contact with the ring electrode at an outer periphery thereof, the central portion of the conductive plate being elastically deformed when the pressing force is applied from above to the central portion of the conductive plate, thereby bring the conductive plate into contact with the second electrode, and

wherein the urging element is configured to be accommodated in the bottom wall in which the base wall portion is formed in the central portion of the urging member in the form of a square sheet as viewed from the top, the rear wall portions are provided at four positions parallel with the side walls to surround the base wall portion and project upward, and a projecting piece is formed to project downward from a back side surface of the base wall portion to come into contact with the central portion of the conductive plate.

With this arrangement, since the square urging element is provided within the side walls disposed the sides of the square, the position or posture of the urging element is fixed. Further, the operation of the sliding element in any of the four directions can be electrically detected while the depressing operation of the sliding element can be electrically detected.

According to the present invention, the bottom wall may include through bores formed therein, and the urging element includes projections formed therein to fit into the through bores. With this arrangement, the projections of the urging element fit into the through bores of the bottom wall, thereby checking movement of the urging element to place the urging element in position relative to the bottom wall.

### BRIEF DESCRIPTION OF THE DRAWINGS

FIG. 1 is an exploded perspective view of a slide switch;

FIG. 2 is a horizontal cross sectional view of the slide switch;

FIG. 3 is a vertical cross sectional view of the slide switch;

FIG. 4 is a horizontal cross sectional view of the slide switch with a slider being slid;

FIG. 5 is a vertical cross sectional view of the slide switch with the slider being slid;

FIG. 6 is a vertical cross sectional view of the slide switch with the slider being depressed;

FIG. 7 is a top plan view of a bottom wall of the slide switch;

FIG. 8 is an exploded perspective view showing side walls and a bottom wall of the slide switch according to a first modified embodiment; and

FIG. 9 is a top plan view of a bottom wall of the slide switch according to a second modified embodiment.

### MODE FOR CARRYING OUT THE INVENTION

Embodiments of the present invention will be described hereinafter in reference to the accompanying drawings. [Fundamental Construction]

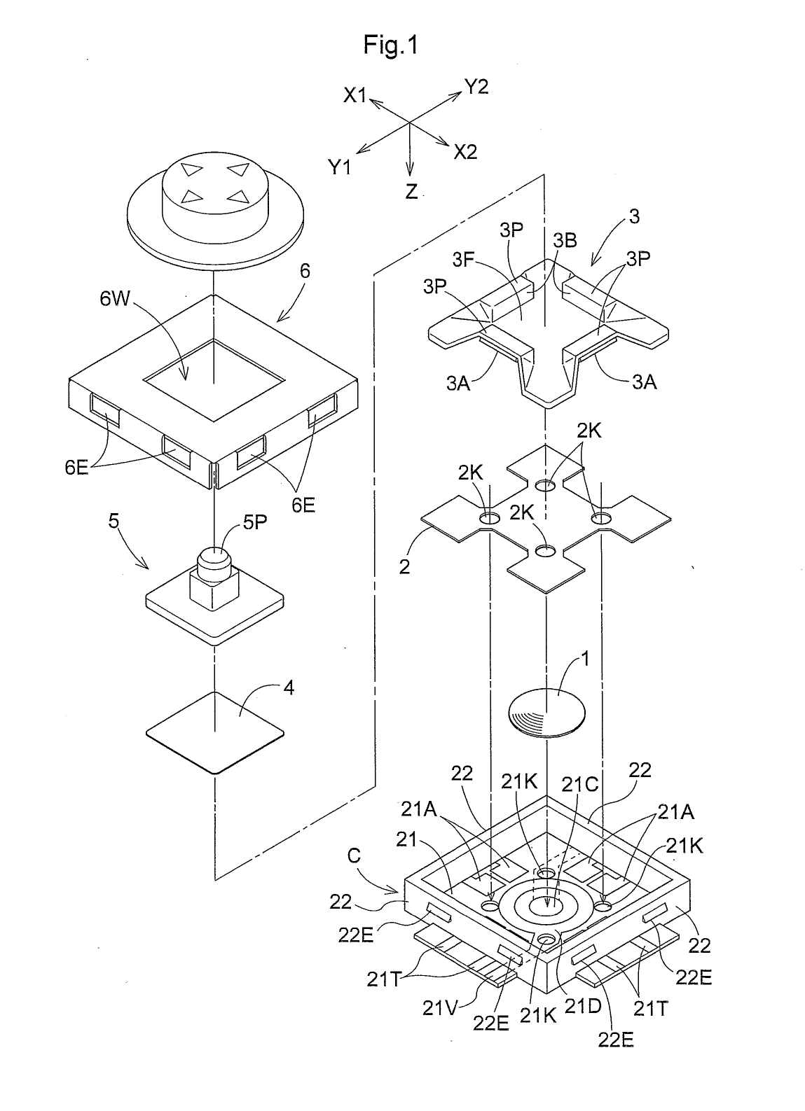

As shown in FIGS. 1 to 3, a slide switch comprises a casing C, a snap conductive plate 1, an adhesive sheet 2, an urging element 3, a slide sheet 4, a slider 5, and a cover 6, which are laid one on top of the other in the mentioned order.

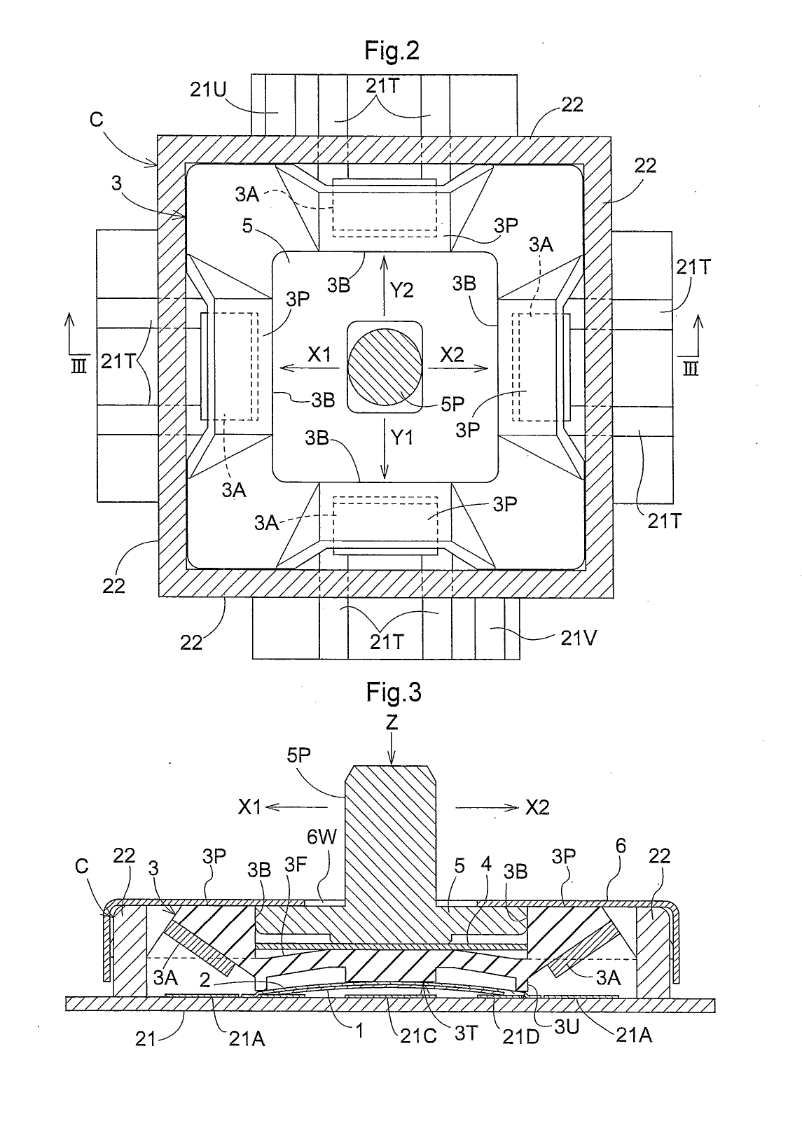

This slide switch is configured so that when the slider 5 is slid in a direction X1, X2, Y1 or Y2 shown in FIGS. 1 and 2 or pressed in a direction Z perpendicular to the aforementioned directions, those operations are electrically detected.

Casing

The casing C is box-shaped including a bottom wall 21 formed as a printed-circuit board, and four side walls 22 provided in each side of a square as viewed from the top, the bottom wall and the side walls being integrated into one piece by insert molding, for example. The four side walls 22 is made of LCP resin (liquid crystal polyester), for example.

A pair of engaging projections 22E are formed outwardly of an outer periphery of each of the four side walls 22. The bottom wall 21 is made of a material having a relatively small thickness with increased strength such as a glass epoxy fiber containing glass fiber impregnated with epoxy resin.

As shown in FIG. 7, a pair of first electrodes 21A are arranged side by side on the bottom wall 21 in the vicinity of each side wall 22 and in a longitudinal middle portion of each side wall 22. A second electrode 21C is arranged in a central portion of the bottom wall 21, and a ring electrode 21D is provided in a concentric circle with respect to the second electrode 21 C.

Further, through bores 21K that vertically extend through the bottom wall 21 are formed at positions corresponding to four corners of the square as viewed from the top in regions surrounding the ring electrode 21D on a top surface of the bottom wall 21.

The first electrode 21A, second electrode 21C and ring electrode 21D are provided by forming metal foil of a good conductor such as copper on the top surface of the bottom wall 21 by a printed-wiring technique. Similarly, terminals 21T that are conductive with the first electrodes 21A are provided at outer ends of the bottom wall 21 in a projecting manner. Further, a terminal 21U and a terminal 21V that are conductive with the second electrode 21C and the ring electrode 21D, respectively, are provided at the outer ends of the bottom wall 21 in a projecting manner. Those terminals 21T, 21U and 21V are formed on both surfaces of the bottom wall 21 and are conductive with each other in each pair via through holes (not shown) to allow soldering to be performed easily and reliably in mounting the slide switch on the substrate.

On the top surface of the bottom wall 21 is formed a circuit for electrically connecting the ring electrode 21D to the terminal 21V. On the bottom surface or at an intermediate layer of the bottom wall 21 is formed a circuit for electrically connecting the second electrode 21C to the terminal 21U via a through hole. The through bores 21K are formed in the positions in which they extend through the circuit for electrically connecting the ring electrode 21D to the terminal 21V and the circuit for electrically connecting the second electrode 21C to the terminal 21U. The regions where the through bores 21K are formed have a large width so as not to disturb electric conduction.

Snap Conductive Plate

The snap conductive plate 1 is an example of conductive plates in the present invention, which is formed as a circular dome, and is brought into contact with the ring electrode 21D at an outer periphery thereof for conduction. The snap conductive plate 1 uses a metal material comprising a good conductor such as phosphor bronze and stainless steel, for example. The snap conductive plate 1 has a central portion that is spaced apart from the second electrode 21C. This arrangement allows the central portion of the snap conductive plate 1 to elastically deform when being pressed down and come into contact with the second electrode 21C to establish a conductive condition.

When the snap conductive plate 1 is deformed, a sense of click is given to the user. More particularly, the roperties of deformation are determined such that the snap conductive plate 1 maintains its dome shape when a small pressing force is applied, while the central portion of the conductive plate 1 is elastically deformed when the pressing force exceeds a predetermined value to come into contact with the second electrode 21C. The snap conductive plate 1 also functions to urge the slider 5 to a neutral position in the pressing-down direction together with a base wall portion 3F of the urging member 3 that will be described later.

Adhesive Sheet and Urging Element

The adhesive sheet 2 has electric insulation properties and uses a resin material having adhesiveness at a back surface thereof (or both of front and back surfaces thereof). The adhesive sheet 2 basically has a contour of a square as viewed from the top to be fitted within the side walls 22 of the casing C that is cut away at the portions where the first electrodes 21A are positioned. The adhesive sheet 2 also has four engaging holes 2K to align with the four through bores 21K formed in the bottom wall 21. The adhesive sheet 2 is placed to cover the snap conductive plate 1 and allow the engaging holes 2K to align with the through bores 21K. Thus, the adhesive sheet 2 is positioned in place due to the adhesiveness thereof.

Further, the urging element 3 has projections (not shown) formed at the back surface thereof that are fitted into the engaging holes 2K of the adhesive sheet 2 and the through bores 21K of the bottom wall 21, thereby to position the adhesive sheet 2 and the urging element 3 relative to the bottom wall 21. Similarly, the projections (not shown) of the urging element 3 are fitted into the through bores 21K of the bottom wall 21, thereby to prevent displacement of the snap conductive plate 1.

The urging element 3 is made of a material that is flexibly and elastically deformable with the electric insulating properties: silicone rubber, EPDM (ethylene propylene diene monomer), and polyethylene elastomer. As shown in FIG. 1, the urging element 3 basically has a contour of a square as viewed from the top to be fitted in the side walls 22 of the casing C, and is positioned and housed inside of the four side walls 22 of the casing C.

The urging element 3 has protrusions 3P formed in a longitudinal central portion of each side to open toward outer peripheries thereof. Rear wall portions 3B are formed to vertically extend from the protrusions 3P to the central portion of the urging element 3. More particularly, the base wall portion 3F is formed at the central region of the urging member 3 that is surrounded by the four rear wall portions 3B as viewed from the top. Each protrusion 3P has a back side (lower side) defining an inclined surface that is close to the bottom wall 21 near the central portion of the urging member 3 and remote from the bottom wall 21 near the outer portion of the urging member 3. A first conductor 3A having a dimension larger than a distance between the two first electrodes 21A is formed on the inclined surface. The first conductor 3A is integrally formed with the urging element 3 by using a conductive material of resin, for example, containing carbon.

Although operations will be described in detail later, the first conductor 3A is spaced from the first electrodes 21A when the slider 5 is not operated. As the protrusions 3P are elastically deformed, the first conductor 3A is brought into contact with the two first electrodes 21A thereby establishing a conductive condition between the pair of the first electrodes 21A.

The base wall portion 3F has a top surface projecting upward gradually or gently toward the central portion thereof, and a back surface extending parallel with the top surface except a central portion thereof that has a projecting piece 3T projecting downward. In this way, the base wall portion 3F has a dome shape as a whole projecting upward to provide a space for arranging the snap conductive plate 1 under the base wall portion 3F.

A pressing portion 3U projects downward from the lower surface of the urging member 3 at an outer peripheral position of the base wall portion 3F which corresponds to a position to hold the adhesive sheet 2 down. The pressing portion 3U comes into contact with the adhesive sheet 2 at a potion spaced apart from the snap conductive sheet 1 to prevent rising of the adhesive sheet 2. It should be noted that the adhesive sheet 2 is extremely thin, though the thickness of the adhesive sheet 2 is described in an exaggerated way in FIG. 5.

Slide Sheet/Slider

The slide sheet 4 is made of a resin sheet material using PET (polyethylene terephthalate) or polyimide that has good sliding properties with a low coefficient of friction. The slide sheet 4 is placed over the top surface of the base wall portion 3F of the urging element 3, and the slider 5 is placed over the top surface of the slide sheet.

The slider 5 corresponds to a sliding element of the present invention. The slider 5 is made of a material such as polyamide that has excellent friction and ablation properties and less produces noise for achieving stable sliding movement. The slider 5 has a main portion having a square that substantially conforms to the shape (a squire in the present invention) of an area surrounded by the rear wall portions 3B of the protrusions 3P of the urging element 3, and a control projection 5P formed on a top surface of a central portion thereof. The slider 5 is brought into contact with the four rear wall portions 3B (or held by the four rear wall portions), thereby to be urged to a neutral position defined as the center of the casing C as viewed from the top.

As noted above, the urging element 3 is made of an elastic material such as rubber and generally has a high coefficient of friction. In contrast, the slide sheet 4 is provided to allow the slider 5 to have good sliding properties in the base wall portion 3F of the urging element 3 having the high coefficient of friction.

Cover

The cover 6 has a contour having substantially the same shape of the square as the contour of the casing C to form a lid with side wall portions being suspended perpendicularly from a flat ceiling portion. The cover 6 has a square window 6W that has an outer shape smaller than the outer shape of the slider 5 and is configured to receive the control projection 5P of the slider 5. Engaged openings 6E are formed in the four side wall portions of the cover 6 to be engageable with the engaging projections 22E formed on the outer peripheries of the side walls 22.

The cover 6 is thinly formed using a metal material having rigidity such as phosphor bronze or stainless steel, for example. This cover serves to prevent exogenous noise from entering the slide switch as well as maintain the strength of the switch.

Assembly

In assembling the slide switch, the snap conductive plate 1 is placed on the central position of the casing C, the adhesive sheet 2 is placed on the top of the snap conductive plate, the urging element 3 is placed over the adhesive sheet, the slide sheet 4 is placed on the base wall portion 3F of the urging element 3, and the slider 5 is laid over the top surface of the slide sheet. Then, the cover 6 is further placed over the slider to apply a force to compress the casing C and the cover 6 in the vertical direction. As a result, the engaged openings 6E of the cover 6 are engaged with the engaging projections 22E of the side wall 22 to fixedly connect the casing C to the cover 6.

With the slide switch assembled in this way, the slider 5 is maintained in the neutral position in the direction of sliding operation by an urging force applied from the urging element 3, while the first electrodes 1A of the casing C are moved away from the first conductor 3A to be maintained in a non-conductive condition. On the other hand, the slider 5 is maintained in the neutral position in the pressing-down direction by an urging force applied upward from the snap conductive plate 1 to allow the second electrode 21C to move away from the snap conductive plate 1 to be maintained in the non-conductive condition.

The projections (not shown) formed on the back surface of the urging element 3 are fitted into the engaging holes 2K and the through bores 21K to secure the adhesive sheet 2 to the urging element 3 to allow the pressing portion 3U to come into contact with the adhesive sheet 2 that is moved away from the snap conductive plate 1, thereby preventing rising of the adhesive sheet 2.

Detection of Operation

As noted above, the control projection 5P is slidable in the directions of the arrows X1, X2, Y1 and Y2, and is depressable in the direction of the arrow Z perpendicular to the directions of X1, X2, Y1 and Y2.

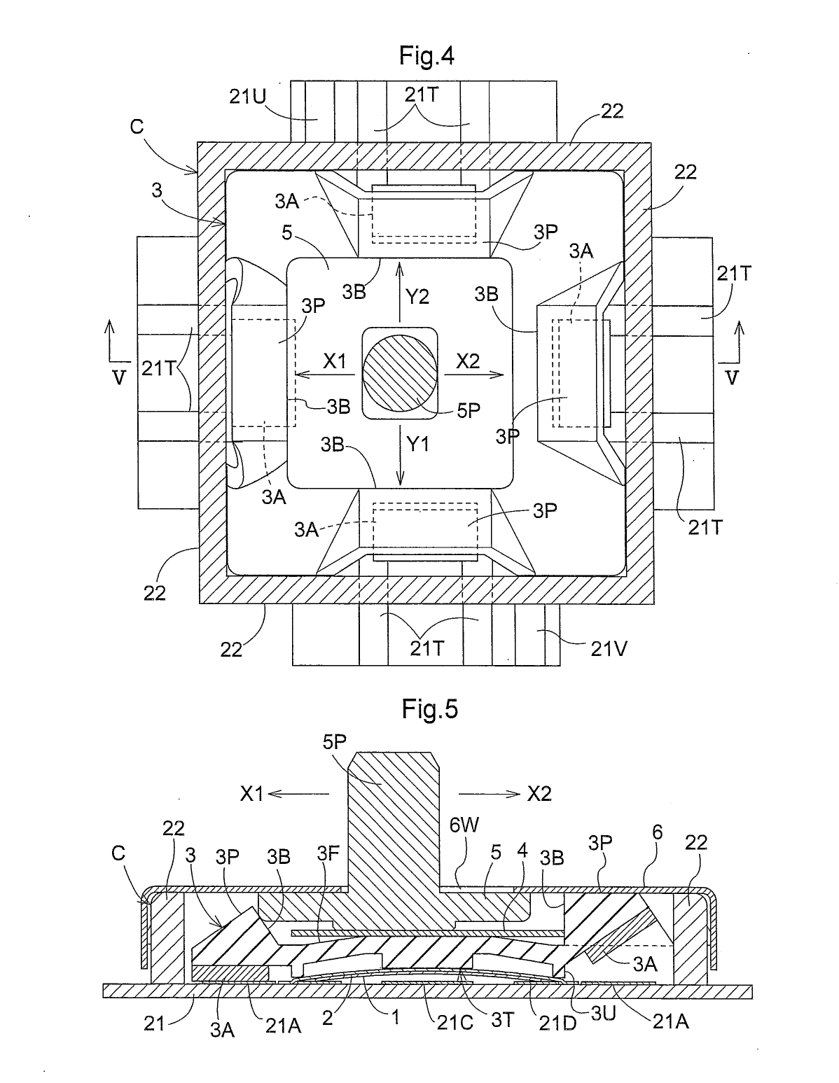

As shown in FIGS. 4 and 5, when the control projection 5P is slid in the direction X1 , for example, the slider 5 is slid together with the control projection 5P to exert a pressing force on one of the rear wall portions 3B in the sliding direction. The associated protrusion 3P tilts down to the moving direction of the slider 5 to be elastically deformed by action of the pressing force z, as a result of which the first conductor 3A is brought into contact with the pair of first electrodes 21A provided in the bottom wall 21 of the casing C to make the pair of first electrodes 21A conductive with each other. The establishment of the conductive condition is electrically measurable at the terminals 21T formed at the bottom wall 21.

The first conductor 3A provided in the urging element 3 and the pair of first electrodes 21A provided in the bottom wall 21 constitute a sliding-operation detecting section together.

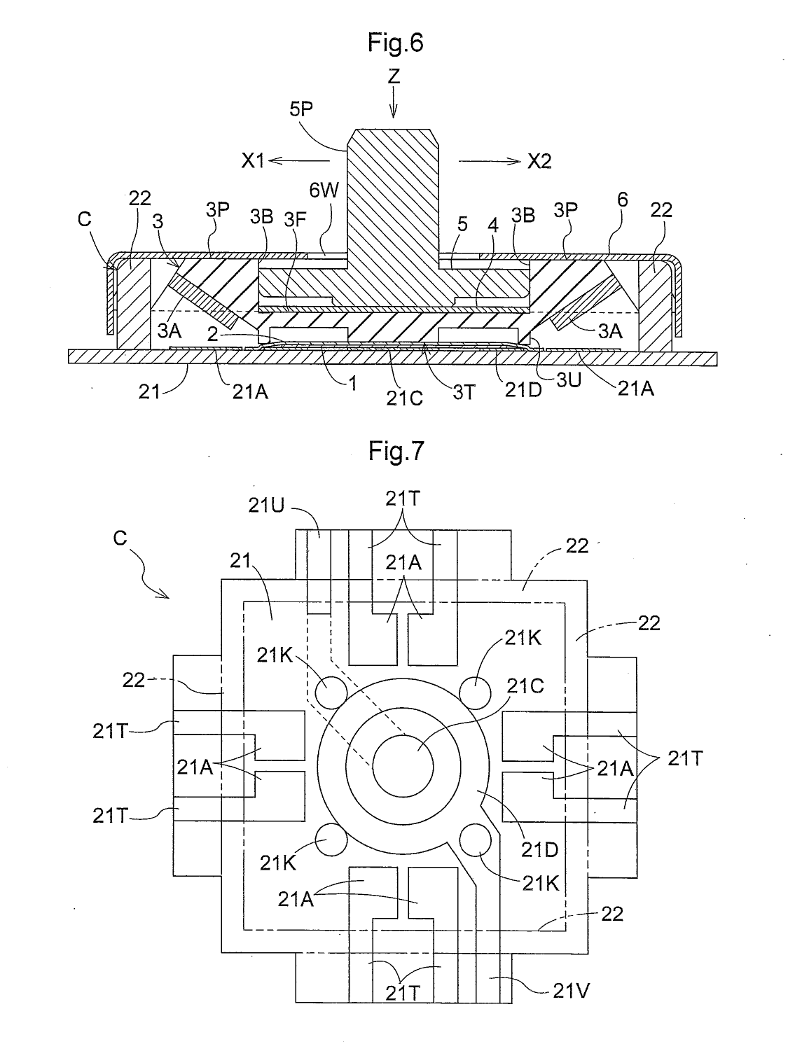

As shown in FIG. 6, when the control projection 5P is depressed in the direction Z, the slider 5 and the base wall portion 3F of the urging element 3 are displaced downward together to allow the projecting piece 3T to exert a pressing force on the central portion of the snap conductive plate 1. The central portion of the snap conductive plate 1 is elastically deformed downward by action of the pressing force to come into contact with the second electrode 21C, thereby making the second electrode 21C and the ring electrode 21D conductive with each other. The establishment of the conductive condition is electrically measurable at the terminals 21U and 21V formed at the bottom wall 21.

It should be noted that, when the control projection 5P is depressed in the direction Z, the sense of click is provided thanks to the above-noted properties of deformation of the snap conductive plate 1.

The snap conductive plate 1, the ring electrode 21D formed on the bottom wall 21 and the second electrode 21C formed on the bottom wall 21 constitute a depressing-operation detecting section together.

First Modified Embodiment

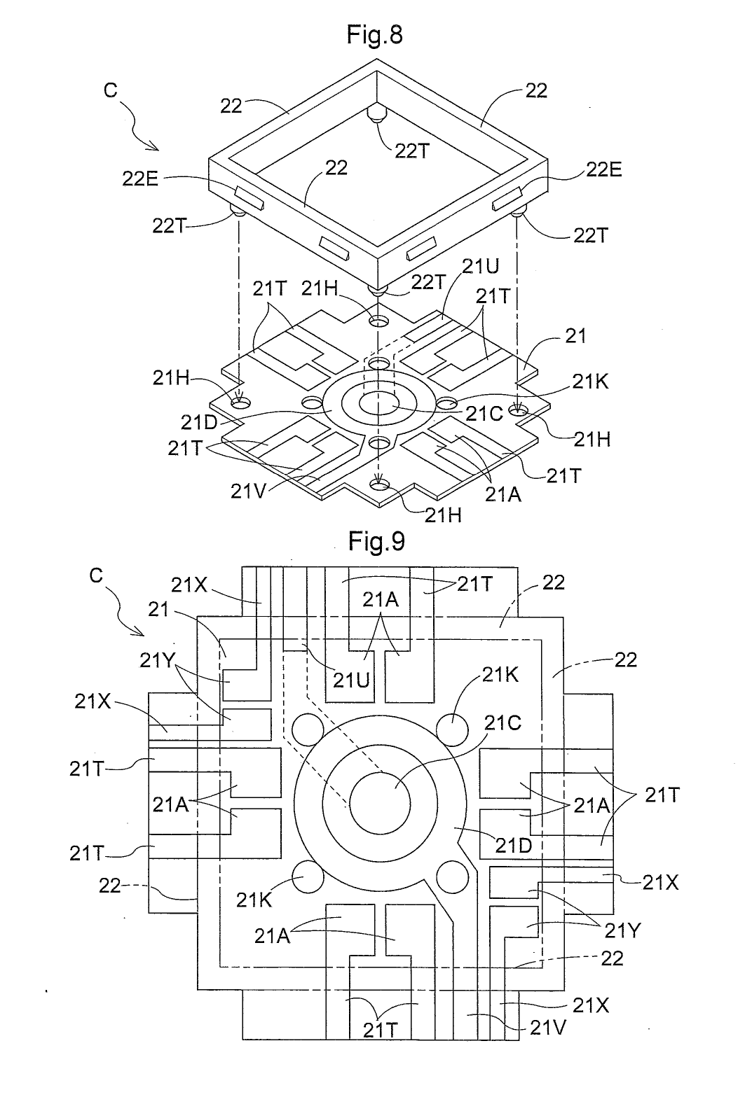

An arrangement is proposed in which a bottom wall 21 formed from a printed-circuit board and four side walls 22 provided separately from the bottom wall are integrally formed as follows. As shown in FIG. 8, a plurality of through bores 21H are formed in the bottom wall 21, while connecting pieces 22T extending through the through bores 21H are provided to project from lower side surfaces of the side walls 22. Projecting ends of the connecting pieces 22T are heated with the connecting pieces 22T extending through the associated through bores 21H to join the respective connecting pieces 22T with the respective through bores 21H by caulking using a thermal fusion bonding technique.

Such a joint arrangement allows the bottom wall 21 and the side walls 22 that are provided separately from each other to be easily joined together, and is adaptable to variations of the specifications of the slide switch when the construction of the side walls 22 is changed, for example.

Second Modified Embodiment

As shown in FIG. 9, lands 21Y are formed on a bottom wall 21 having a print-circuit board, to which lands electric power is supplied from outside via external terminals 21X. Light-emission diodes, for example, are mountable on those lands 21Y

In the second modified embodiment, the light-emission diodes are incorporated to achieve power supply from the lands 21Y to provide an illumination-type switch in which the light-emission diodes illuminate within the slide switch when the switch is operated, for example, so that the operator may recognize the operational status.

Third Modified Embodiment

The slider 5 may be operable in six directions or eight directions, instead of the four directions. Such an arrangement achieves control based on a required operation in response to a selected operational mode.

Effect to be Achieved

According to the present invention, since the bottom wall 21 employs a print-circuit board having increased strength made of fiber impregnated with resin such as a glass epoxy substrate containing glass fiber impregnated with epoxy resin, the casing C can be thin to reduce the thickness (vertical dimension in FIG. 3) of the slide switch.

Further, the bottom wall 21 is constituted with the print-circuit board to form the first electrodes 21A, second electrode 21C and ring electrode 21D at desired positions with high accuracy using the print-wiring technique. The terminals 21T, terminals 21U and terminals 21V that are conductive with those electrodes are also provided at desired positions with high accuracy.

In addition, since the urging element 3 has the dome-like base wall portion 3F to provide the space between the base wall portion 3F and the bottom wall 21 for accommodating the snap conductive plate 1, the thickness of the slide switch can be more reduced.

The adhesive sheet 2 is placed on the top surface of the snap conductive plate 1 to restrain displacement of the snap conductive plate 1 and maintain the fixed and secure sense of click.

Still further, the terminals 21T, terminals 21U and terminals 21V are formed at the outer ends of the bottom wall 21, which makes it possible to enhance the accuracy of the positions where those terminals 21T, terminals 21U and terminals 21V are formed relative to the casing C. As a result, when the slide switch is mounted on a print-circuit board of an apparatus, soldering and fixing is easily performed.

The engaging holes 2K of the adhesive sheet 2 are aligned with the through bores 21K formed in the bottom wall 21 to allow the projections formed at the back surface of the urging element 3 to fit into the engaging holes 2K and the through bores 21K. This restrains displacement of the adhesive sheet 2 and the urging element 3 relative to the bottom wall 21 to place the adhesive sheet 2 and the urging element 3 in position.

### INDUSTRIAL APPLICABILITY

The present invention is applicable to a slide switch that can be reduced in thickness.

1. A slide switch comprising:
a sliding element slidable relative to a casing;
an urging element for urging the sliding element in an neutral position in a direction of sliding operation;
a sliding-operation detecting section for electrically detecting an operation of the sliding element in the direction of sliding operation; and
a depressing-operation detecting section for electrically detecting a depressing operation of the sliding element in a direction perpendicular to the sliding-operation detecting section,
wherein the urging element includes rear wall portions provided in a projecting way at a plurality of positions to hold the sliding element,
wherein the sliding-operation detecting section includes a first electrode formed on a bottom wall of the casing, and a first conductor that is elastically deformed when a pressing force is applied from the sliding element to one of the rear wall portions to come into contact with the first electrode, thereby establishing an electrically conductive condition,
wherein the depressing-operation detecting section includes a second electrode formed in a central position of the bottom wall of the casing, and a conductive plate having a central portion projecting toward the urging element, in which a base wall portion of the urging element corresponding to an area surrounded by the rear wall portions is elastically deformed when the sliding element is depressed to elastically deform the central portion of the conductive plate by a pressing force and bring the conductive plate into contact with the second electrode, thereby establishing the electrically conductive condition, and
wherein the bottom wall is constituted with a print-circuit board formed by a print-wiring technique.

2. The slide switch as claimed in claim 1, wherein the base wall portion includes a portion corresponding to the central portion of the conductive plate that projects toward the sliding element.

3. The slide switch as claimed in claim 1, wherein the casing includes four side walls provided at each side of a square as viewed from the top,
wherein the second electrode and a ring electrode surrounding the second electrode concentrically are formed on the central position of the bottom wall surrounded by the side walls,
wherein the conductive plate is arranged to be constantly in contact with the ring electrode at an outer periphery thereof, the central portion of the conductive plate being elastically deformed when the pressing force is applied from above to the central portion of the conductive plate, thereby bring the conductive plate into contact with the second electrode, and
wherein the urging element is configured to be accommodated in the bottom wall in which the base wall portion is formed in the central portion of the urging member in the form of a square sheet as viewed from the top, the rear wall portions are provided at four positions parallel with the side walls to surround the base wall portion and project upward, and a projecting piece is formed to project downward from a back side surface of the base wall portion to come into contact with the central portion of the conductive plate.

4. The slide switch as claimed in claim 1, wherein the bottom wall includes through bores formed therein, and the urging element includes projections formed therein to fit into the through bores.
